(19) United States
(12) Patent Application Publication
(10) Pub. No.: US 2025/0247870 A1
(43) Pub. Date: Jul. 31, 2025

(54) SIDELINK SERVICES IN WIRELESS COMMUNICATIONS SYSTEMS

(71) Applicant: T-Mobile USA, Inc., Bellevue, WA (US)

(72) Inventor: Gaviphat Lekutai, Kirkland, WA (US)

(21) Appl. No.: 18/422,658

(22) Filed: Jan. 25, 2024

(51) Int. Cl. E05G 1/10; H04W 72/40

(52) U.S. Cl. CPC H04W 72/40

(57) ABSTRACT

Systems and methods for performing authorization and access operations using sidelink communications supported by cellular standards are described. A UE may use sidelink communications to verify itself with one or more proximate devices and to establish that it is within a required area and/or proximate to another required device. The UE may provide access data to a sidelink relay device for authorization operations performed in conjunction with a remote device via cellular communications between the relay device and the remote device. Based on such operations, an access and/or authorization determination may be made by the remote device and access and/or authorization may be remotely controlled and/or performed by the relay device.

### BACKGROUND

The number of cellular communications devices (e.g., user devices such as mobile telephones, smartphones, tablets, laptops, etc.) and other types of computing devices connected via cellular communications networks has rapidly grown as the cost of such devices and network connectivity has decreased. Along with increases in the number and capability of devices, the variety of services available to such devices has also increased. However, short-range wireless services, if available, are configured and controlled separately from cellular communications services on cellular communications devices, increasing the cost and complexity of offering both cellular and short-range communications capabilities on a single device.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communications network environment in which systems and methods for sidelink services in wireless communications systems may be implemented, in accordance with examples of the disclosure.

FIG. 2 is a signal flow diagram of illustrative functions and communications that may be implemented in a wireless communications system in which systems and methods for sidelink services may be implemented, in accordance with examples of the disclosure.

FIG. 3 is a signal flow diagram of illustrative functions and communications that may be implemented in a wireless communications network in which systems and methods for sidelink services may be implemented, in accordance with examples of the disclosure.

FIG. 4 is a flow diagram of an illustrative process for performing sidelink services in wireless communications systems, in accordance with examples of the disclosure.

FIG. 5 is a schematic diagram of illustrative components in an example user device that is configured for interacting with a wireless communications system that implements sidelink services, in accordance with examples of the disclosure.

FIG. 6 is a schematic diagram of illustrative components in an example computing device that is configured for performing one or more aspects of implementing sidelink services, in accordance with examples of the disclosure.

### DETAILED DESCRIPTION

### Overview

This disclosure is directed in part to systems and techniques for implementing sidelink services in wireless communications networks and/or systems. Such networks and systems include any networks that may facilitate wireless communications services for one or more wireless communications devices. Such networks include networks that support one or more 3GPP standards, including, but not limited to, Long Term Evolution (LTE) networks (e.g., 4G LTE networks) and New Radio (NR) networks (e.g., 5G NR networks), 6G networks, WiFi networks, short-range wireless networks, local networks, and any combination thereof. However, the disclosed systems and techniques may be applicable in any network or system in which one user device may communicate with one or more other proximate local devices of any type.

In conventional systems, a wireless user device (e.g., mobile telephone, smartphone, user equipment (UE), etc.) may wirelessly communicate with a base station (e.g., gNodeB, eNodeB, NodeB, base transceiver station (BTS), etc.) to request wireless communications services, such as a packet data communication session between the user device and a data network (e.g., the Internet, an IP multimedia system or subsystem (IMS), etc.) to provide a specific type of service (e.g., voice service, video service, Internet service). Various operations may be performed by network components, devices, and/or functions to obtain or otherwise establish the requested services for the wireless user device. The service requested by the (source) wireless user device may include a communications connection to another (destination) wireless user device, even if the source and destination wireless user devices are proximate to (e.g., physically near) one another.

Many wireless user devices support short-range wireless technologies that are independent and distinct from the cellular communications technologies (e.g., 3GPP standards-based technologies) that such devices may also support. Such short-range wireless technologies may include Bluetooth, wireless USB, NearLink, and Zigbee. However, these short-range wireless technologies typically lack the security features of cellular communication technologies, making their use for secure communications, such as authentication, authorization, and access operations, less desirable. Moreover, the implementation of such short-range wireless technologies on a wireless user device requires that the device be configured with hardware and/or software that is independent of the hardware and software configured at the device for cellular communications. Such short-range wireless hardware and/or software may add resources to a device that may be distinct from cellular hardware and/or software, adding expense and complication to a wireless device for features that may be rarely or never used.

In examples, to provide secure short-range communications services without requiring additional non-cellular communications hardware and/or software at a wireless user device, such short-range services may be implemented using the cellular components of a wireless user device that implements a wireless communications standard, such as 4G, 5G, or 6G. In the disclosed examples, sidelink communications technology as integrated into the cellular standards implemented by a wireless user device may be used to provide short-range communications. For instance, the disclosed examples may use LTE sidelink as defined in 3GPP's 4G standard, NR sidelink as defined in 3GPP's 5G standard, and/or sidelink as defined in 3GPP's 6G standard. As used herein, “sidelink” may refer to any one or more of such implementations of sidelink communications technology.

In examples, sidelink may be used to complete secure transactions that involve authorization and/or access operations where the proximity of two users and/or their devices is key to ensuring that the appropriate users are participating in such transactions. In such examples, two or more wireless user devices may interact with one another using sidelink communications to exchange authorization and/or access data and to perform related operations. Alternatively or additionally, two or more wireless user devices may interact with a sidelink relay device using sidelink communications to exchange authorization and/or access data and to perform related operations. The relay device may then perform additional operations using cellular communications to exchange data with one or more remote devices via a wireless communications network.

In examples, transactions that require the participation of two (or more) particular individuals may be facilitated by using wireless user devices exchanging communications using sidelink. For instance, access to a physical item or space, such as a safe deposit box or secure area, may be conditioned on successful access authorization operations performed by two or more wireless user devices directly interacting with each other using sidelink communications. Such operations may be further facilitated by a relay wireless communications device that may exchange data directly with one or more such wireless user devices via sidelink and exchange data with a remote device via a wireless (e.g., cellular) network.

For example, access to a safe deposit box may be conditioned on the proximate physical presence of two associated users, such as a bank employee and a bank customer associated with the safe deposit box. To initiate access to a safe deposit box, a bank employee wireless user device may establish a sidelink communications session with a bank customer wireless user device. The bank employee wireless user device may request and/or receive access data (e.g., a key (public key/private key), code, user identifier, device identifier, etc.) from the bank customer wireless user device via the sidelink communications session. The bank customer wireless user device may also, or instead, request and/or receive access data (e.g., a key (public key/private key), code, user identifier, device identifier, etc.) from the bank employee wireless user device via the sidelink communications session. One or both of the bank employee wireless user device and the bank customer wireless user device may then verify the other device. In some examples, the ability to establish a sidelink communications session between these two devices may indicate that the bank employee wireless user device and the bank customer wireless user device are physically proximate. Alternatively or additionally, the bank employee wireless user device and the bank customer wireless user device may exchange data (e.g., location data, GPS coordinates, etc.) that may allow one or both such devices to determine an estimated distance between itself and the other device.

Upon verification of the two devices and a determination that they are sufficiently proximate to one another, the bank employee wireless user device may serve as a sidelink relay wireless user device and establish a wireless (e.g., cellular) communications session with a remote device or system that may be configured to control access to safe deposit boxes. The bank employee wireless user device may exchange data with this remote device or system that may allow the remote device or system to verify that both the bank employee wireless user device and the bank customer wireless user device are proximate to each other and proximate to a particular safe deposit box. Such exchanged data may include safe deposit box information, bank customer information, bank employee information, associated device information, and/or any other information that may help ensure that the appropriate users are present and proximate to the safe deposit box. Upon verifying such information, the remote device or system may allow access to the safe deposit box by, for example, remotely unlocking or releasing the safe deposit box and/or taking one or more actions to facilitate access to the contents of the safe deposit box.

One or both of the bank employee wireless user device and the bank customer wireless user device may also, or instead, establish a sidelink communications session with a relay wireless device that may be located proximate to the safe deposit box and may be distinct from both the bank employee wireless user device and the bank customer wireless user device. For example, the safe in which the safe deposit box is located may have a dedicated safe deposit box access system that includes a wireless device. By establishing a sidelink communications session with each of the bank employee wireless user device and the bank customer wireless user device, this safe deposit box access system may confirm that both the bank employee wireless user device and the bank customer wireless user device are proximate to the safe deposit box. The bank employee wireless user device and/or the bank customer wireless user device may exchange access data (e.g., a key (public key/private key), code, user identifier, device identifier, etc.) with the safe deposit box access system instead of, or in addition to, exchanging access data with each other as described above.

The safe deposit box access system may determine whether the safe deposit box should be unlocked or otherwise made accessible based on the data exchanged with one or more both of the bank employee wireless user device and the bank customer wireless user device. Upon verification, the safe deposit box access system may allow access to the safe deposit box by, for example, unlocking or releasing the safe deposit box and/or taking one or more actions to facilitate access to the contents of the safe deposit box.

Alternatively or additionally, the safe deposit box access system may serve as a sidelink relay wireless user device and establish a wireless (e.g., cellular) communications session with a remote device or system that may be configured to control access to safe deposit boxes. The safe deposit box access system may itself verify the two devices and determine that they are sufficiently proximate to the safe deposit box access system (and therefore to the safe deposit box) and/or the safe deposit box access system may provide access and/or proximity data to a remote device or system that may be configured to control access to safe deposit boxes. The safe deposit box access system may exchange data with this remote device or system that may allow the remote device or system to verify that both the bank employee wireless user device and the bank customer wireless user device are proximate to each other and proximate to a particular safe deposit box.

Such exchanged data may include an indication that the safe deposit box access system has established a sidelink communications session with each of the bank employee wireless user device and the bank customer wireless user device, which the remote device or system may use to determine that the bank employee wireless user device and the bank customer wireless user device are sufficiently proximate to the safe deposit box access system (and therefore the safe deposit box). Such exchanged data may also, or instead, include safe deposit box information, bank customer information, bank employee information, associated device information, and/or any other information that may help ensure that the appropriate users are present and proximate to the safe deposit box. Upon verifying such information, the remote device or system may allow access to the safe deposit box by, for example, remotely unlocking or releasing the safe deposit box and/or taking one or more actions to facilitate access to the contents of the safe deposit box.

In other examples, similar and varying exchanges of data using sidelink communications in combination with cellular communications may be used to complete various operations. For example, similar operations may be performed to authorize a check, money transfer, or other (e.g., financial) transaction that requires the authorization of two or more particular individuals. In such an example, a bank employee wireless user device may be configured to use sidelink communications to receive access data from two bank customer wireless user devices that the bank employee wireless user device may then use to exchange data (including transaction information) with a remote system or device via a cellular communications network. The remote system or device may determine whether the transaction may proceed based on the data received from the bank employee wireless user device, including data that indicates that the two bank customer wireless user devices are physically proximate to the bank employee wireless user device (e.g., data indicating that the bank employee wireless user device was able to establish a sidelink communications session with each of the two bank customer wireless user devices and/or data indicating that the two bank customer wireless user devices were able to establish a sidelink communications session with each other).

In other examples, access to a physical space may be restricted based on a proximity of an authorized user's device. In such examples, an access system or device may require the establishment of a sidelink communications session with a wireless user device and the receipt of acceptable access data (e.g., a key (public key/private key), code, user identifier, password, device identifier, etc.) from that wireless user device via the sidelink communications session. The access system or device may function as a sidelink relay device, exchanging received access data with a remote system via a wireless (e.g., cellular) communications network to determine whether the user operating the wireless user device may be granted access to the physical space. Upon determining that access is to be granted, the remote system and/or the access system or device may enable physical access to the space by, for example, unlocking and/or opening a door, enabling a turnstile, etc. In some examples, additional steps may also be required of the wireless user device. For instance, the wireless user device may be configured to request a code or password from the user in real time that may be provided to the access system or device for further authorization operations.

In any examples described herein, one or more applications configured on a wireless user device may operate in conjunction with sidelink communications to enable the described aspects. For example, an access application may be configured on a wireless user device that controls interactions with other wireless devices to enable authorization and other access operations.

The operations conducted as described herein may be performed using data packets exchanged via sidelink communications technology. Thus, the wireless devices described herein may generate and exchange such packets to perform the operations. The packets may be processed at layer 2 and/or layer 3 components/functions. The devices described herein may use unlicensed bands to exchange sidelink communications, thereby increasing the efficiency of the wireless (e.g., cellular) network by reducing the usage of licensed bands for communications between proximate wireless devices (e.g., proximate devices may use sidelink as described herein on unlicensed bands instead of communicating through the wireless network using licensed bands). This may free up licensed bandwidth for longer distance communications and/or other wireless communications devices.

By facilitating the use of sidelink communications for operations that involve physically proximate wireless devices, the systems and methods described herein provide more efficient and secure authorization and access operations and reduced resource utilization. By minimizing the use of cellular communications resources by using local device-to-device communications technology, the systems and methods described herein can improve the performance and increase the efficiency of both network and user resources. Moreover, by using device-to-device technology fully supported in the cellular technologies configured wireless devices, the systems and methods described herein can increase the security of access and authorization communications without adding hardware and/or software to devices that may be redundant and little-used. For example, the methods and systems described herein may be more efficient and/or more robust than conventional techniques, as they may increase the speed of the communications between proximate UEs by avoiding generating cellular network traffic, thereby increasing the responsiveness of the UEs while also reducing traffic on the network, freeing resources that may be put to better use for longer distance communications. That is, the methods and systems described herein provide a technological improvement over existing access and authorization operations by reducing network traffic associated with such operations and increasing the security of local (device-to-device) communications by taking advantage of the security features included in the cellular communications technologies that implement sidelink. In addition to improving the efficiency of network and device resource utilization, the systems and methods described herein can provide more robust systems by, for example, making more efficient use of network devices by reducing unnecessary and/or unproductive device and network signaling and processing associated with communication between two or more physically proximate devices, thereby freeing network and device resources for more productive operations.

Illustrative environments, signal flows, and techniques for implementing systems and methods for sidelink services in wireless communications systems are described below. However, the described systems and techniques may be implemented in other environments.

### Illustrative System Architecture

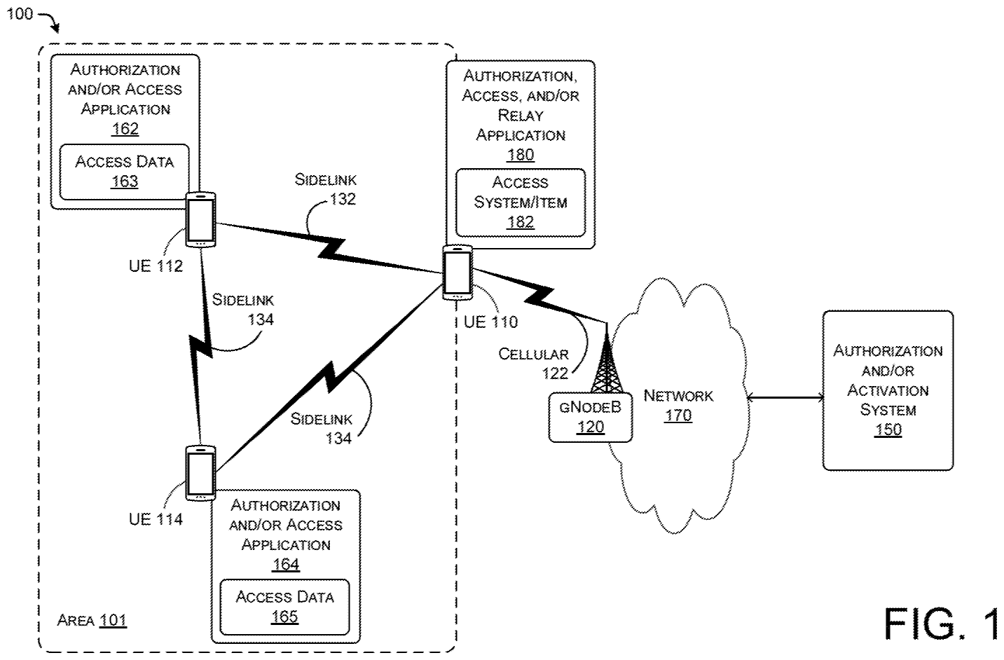

FIG. 1 is a schematic diagram of an illustrative wireless network environment 100 in which the disclosed systems and techniques may be implemented. The environment 100 may include an area 101 in which a UE 110, a UE 112, and a UE 114 may each wirelessly communicate with one another using sidelink communications. In examples, the area 101 may be a limited physical space or area, such as a room, building, zone, etc., such that the UE 110, the UE 112, and the UE 114 are relatively proximate to one another. In examples, the area 101 may be a room in a bank or other financial institution. In other examples, the area 101 may be an area that provides access to a limited access building, room, or space, such as an entryway to a restricted access building, room, or space.

One or more of the UE 110, the UE 112, and the UE 114 may also communicate with the gNodeB 120. In particular examples, the UE 110 may communicate with the gNodeB 120, while the UE 112 and the UE 114 may not communicate with the gNodeB 120, for example, as part of the operations performed according to the disclosed systems and techniques (in such examples, the UE 112 and/or the UE 114 may communicate with the gNodeB 12 for other purposes). While referred to as a “gNodeB” for explanatory purposes herein, the gNodeB 120 may be any type of base station, including, but not limited to, any type of BTS, NodeB, eNodeB, gNodeB, etc.

The gNodeB 120 may communicate with other systems, components, and functions in and/or via a network 170. The network 170 may be any one or more networks that facilitate communications between particular devices, components, and/or functions of various types, including a wireless communications network that may facilitate communication between computing devices and/or mobile devices (e.g., UEs). Various connections between components and functions in the network 170 may be wired, wireless, or a combination thereof. The components and functions described herein may be implemented as physical devices, as software components and/or functions executing on one or more computing devices, and as any combination thereof. In various embodiments, the network 170 may facilitate the establishment of communications sessions (e.g., PDU sessions) for one or more wireless devices, such as any one or more of the UE 110, the UE 112, and the UE 114. In examples, the network 170 may facilitate packet-based communications between such wireless devices and other wireless devices, devices on the Internet, one or more IMSs, and/or one or more other data networks (DNS). In examples, the network 170 may facilitate communications between the UE 110 and an authorization and/or activation system 150.

The authorization and/or activation system 150 may be a system that determines, based on access data, whether to allow access to a restricted area or system and/or whether to authorize a transaction (e.g., a financial transaction). The system 150 may also, or instead, perform any other types of authorization and/or access operations based on access data. In FIG. 1, connections between the system 150 and the UE 110 may be logical connections that may be facilitated by the network 170 and may include traversal of one or more devices, components, and/or functions that may or may not be shown in FIG. 1, such as devices, components, and/or functions within the network 170.

In environment 100, one or more of the UE 110, UE 112, and UE 114 may be configured with one or more authorization and/or access components (e.g., applications) that may facilitate the disclosed operations. For example, the UE 112 may be configured with an authorization and/or access application 162 that may be configured to exchange access data 163 with one or more other device via sidelink. Access data 163 may include one or more keys (public key/private key), codes, user identifiers, passwords, device identifiers, etc. associated with a user of the UE 112. Similarly, the UE 114 may be configured with an authorization and/or access application 164 that may be configured to exchange access data 165 with one or more other device via sidelink. Access data 165 may include one or more keys (public key/private key), codes, user identifiers, passwords, device identifiers, etc. associated with a user of the UE 114.

The UE 112 may provide access data 163 to the UE 114 via sidelink communications connection 134 and/or UE 114 may provide access data 165 to the UE 112 via sidelink communications connection 134. The application 162 configured at the UE 112 may process access data 165 received from the UE 114 via the sidelink communications connection 134. The application 164 configured at the UE 114 may process access data 163 received from the UE 112 via the sidelink communications connection 134.

The UE 112 may exchange access data (e.g., access data 163) and/or other communications with the UE 110 via sidelink communications connection 132. The UE 114 may exchange access data (e.g., access data 165) and/or other communications with the UE 110 via sidelink communications connection 134. The UE 110 may be configured with an authorization, access, and/or relay application 180 configured to process such access data and/or to relay such access date to a remote access system. In examples, the UE 110, executing the application 180, may generate and/or relay access data to the authorization and/or activation system 150 that may determine whether to authorize a transaction, allow access to a remote system, etc. The UE 110 may communicate with the system 150 using a cellular communications connection 122 to the gNodeB 120 that may facilitate communication with the system 150 via the network 170.

The system 150 may determine whether to allow access to and/or authorize transactions involving a particular item or space within or proximate to the area 101. For example, the system 150 may determine whether to allow access to an access system/item 182. Access to the access system/item 182 may be controlled directly by the system 150 and/or may be controlled by the application 180 in response to data received from the system 150.

For example, the system 150 may control a locking mechanism or other means of access to a safe deposit box that may be represented as system/item 182. The system 150 may control this access means to allow access to the safe deposit box (system/item 182) upon verifying access data as described herein. Alternatively or additionally, the application 180 may control a locking mechanism or other means of access to the safe deposit box represented as system/item 182. The application 180 may control this access means to allow access to the safe deposit box (system/item 182) upon receiving data from the system 150 indicating that the system 150 has verified access data associated with the safe deposit box (system/item 182) as described herein.

In examples, access to the system/item 182 may be conditioned on the proximate physical presence of two associated users, such as the user of the UE 112 and the user of the UE 114. For example, the system/item 182 may be a safe deposit box or other physical item or space to which access is restricted. To initiate access to the system/item 182, an access management device may execute an access management component to control access to the system/item 182. The UE 110 may represent such an access management device executing application 180 that may function as an access management component. The UE 110 may request and/or receive access data 163 from the UE 112 and/or by interacting with the application 162 via the sidelink communications connection 132. The UE 112 may also, or instead, request and/or receive access data or other information from the UE 110 via the sidelink communications connection 132. The UE 110 may also request and/or receive access data 165 from the UE 114 and/or by interacting with the application 164 via the sidelink communications connection 134. The UE 114 may also, or instead, request and/or receive access data or other information from the UE 110 via the sidelink communications connection 134. The application 180 executing on the UE 110 may interact with the system 150 via the cellular communications connection 122 and the network 170 to verify that the UE 112 and the UE 114 are proximate to the system/item 182. The application 180 executing on the UE 110 may indicate to the system 150 that both UE 112 and UE 114 are proximate to the UE 110 and/or within the area 101 based on successfully establishing sidelink communications with those UEs. That is, the establishment of the short-range wireless connection using sidelink may be sufficient to indicate that the UE 112 and the UE 114 are present in the vicinity of the system/item 182. Alternatively, the application 180 executing on the UE 110 may interact with the UE 112 (e.g., the application 162 executing on the UE 112) and the UE 114 (e.g., the application 164 executing on the UE 114) to obtain location data for those devices via their respective sidelink communications connections with the UE 110. Such location information may be determined by the UE 112 and the UE 114 using location determination components and/or means (e.g., a GPS component or other location determining component) and transmitted to the UE 110 via the sidelink communications connections.

Alternatively or additionally, the UE 112 (e.g., the application 162 executing on the UE 112) may verify the UE 114 (e.g., by interacting with the application 164 executing on the UE 114) or vice versa, and the verifying device may communicate verifying data to the UE 110 via it sidelink communications connection with the UE 110. The application 180 executing on the UE 110 may interact with the system 150 via the cellular communications connection 122 and the network 170 to verify that the UE 112 and the UE 114 are proximate to the system/item 182. The application 180 executing on the UE 110 may indicate to the system 150 that both UE 112 and UE 114 are proximate to the UE 110 and/or within the area 101 based on successfully establishing sidelink communications with the verifying UE (e.g., the UE 112) and receiving data from the verifying UE that the verifying UE has successfully established sidelink communications with the verified UE (e.g., the UE 114). That is, the establishment of the short-range wireless connections amongst the various UEs using sidelink may be sufficient to indicate that the UE 112 and the UE 114 are present in the vicinity of the system/item 182. Alternatively, the application 180 executing on the UE 110 may interact with the verifying UE (e.g., the UE 112) to obtain location data (e.g., GPD coordinates, location data, etc.) for both the verifying UE and the verified UE (that may provide location information to the verifying UE via sidelink).

Upon verification of the UE 112 and the UE 114 and a determination that they are sufficiently proximate to one another and/or to the system/item 182, the UE 110 may serve as a sidelink relay wireless user device and establish a wireless (e.g., cellular) communications session with the system 150 via the cellular communications connection 122. Alternatively, the UE 110 may serve as a sidelink relay wireless user device and establish a wireless (e.g., cellular) communications session with the system 150 via the cellular communications connection 122 and provide access data collected by the application 180 from the UE 112 and the UE 114 for to system 150 to process to determine whether the UE 112 and the UE 114 are verified and sufficiently proximate to one another and/or to the system/item 182. The UE 110 executing the application 180 may exchange data with the system 150 that may include an acceptance or rejection of the provided access and/or proximity data. Based on this data, the UE 110 executing the application 180 may allow or deny access to the system/item 182.

In other examples, sidelink communications in combination with cellular communications may be used between the UEs 110, 112, and/or 114 to complete various other access and/or authorization operations. For example, a financial transaction that requires the authorization of two or more particular individuals may be verified by confirming the physical proximity of the UE 112 and the UE 114 via the UE 110 and/or by the system 150. Access to a physical space proximate to or within the area 101 may be determined by confirming the physical proximity of the UE 112 and the UE 114 via the UE 110 and/or by the system 150. The environment 100 and/or the components and devices therein may be used to implement various other access and/or authorization operations according to the systems and methods of the instant disclosure.

### Illustrative Signal Flows

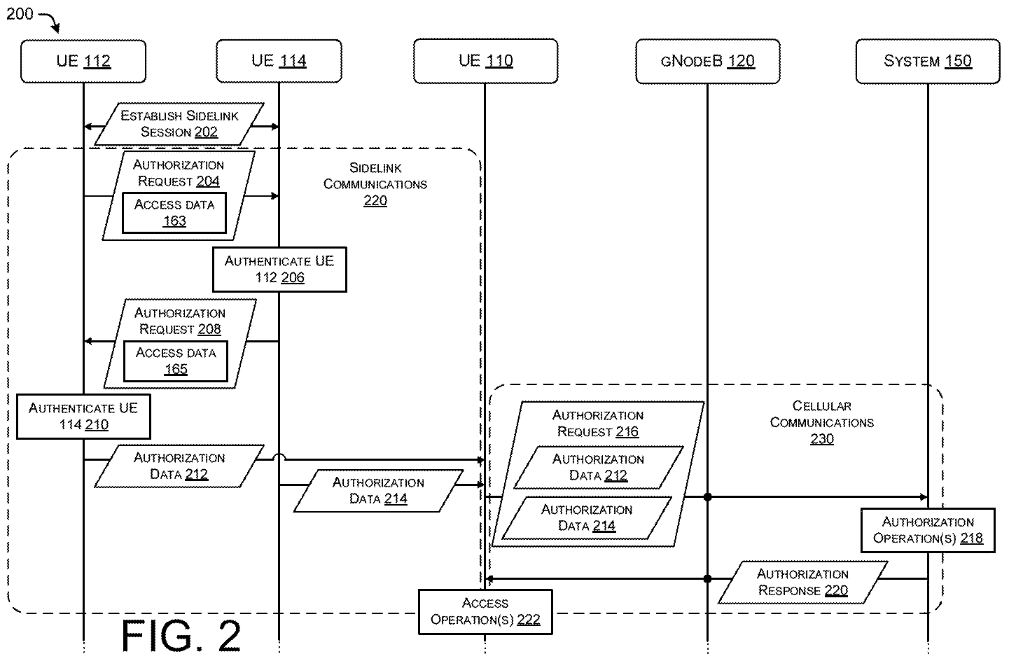

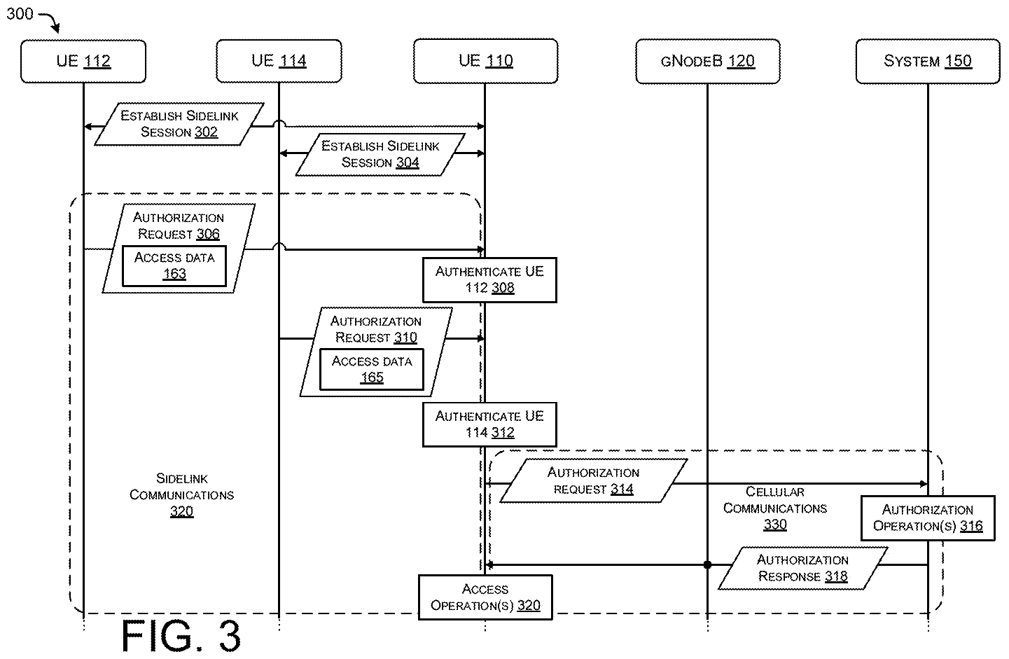

FIGS. 2 and 3 illustrate exemplary signal flows 200 and 300, respectively, of various messages that may be exchanged in one or more of the disclosed systems and techniques for performing access and/or authorization operations using sidelink services in wireless communications networks and/or systems. Reference may be made in this description of the signal flows 200 and 300 to devices, entities, functions, components, and/or interfaces illustrated in FIG. 1 and described in regard to that figure. However, the operations, signals, and signal flow illustrated in FIGS. 2 and 3 and described herein may be implemented in any suitable system and/or with any one or more suitable devices and/or entities. Moreover, any of the operations, signals, and/or entities described in regard to FIGS. 2 and 3 may be used separately and/or in conjunction with other operations, signals, and/or entities. All such embodiments are contemplated as within the scope of the instant disclosure.

Signal flow 200 of FIG. 2 illustrates an example of signals that may be exchanged and operations that may be performed based on a user device verifying another user device or two or more user devices verifying one another (e.g., the UE 112 and the UE 114) via sidelink and then providing access data via sidelink to a sidelink relay device (the UE 110) for access authorization determination with a remote system (the system 150) via cellular communications.

In an example, the UE 112 and the UE 114 may establish a sidelink communications session with one another at operation 202. In examples, the UE 112 and the UE 114 may then engage in authorization operations to verify one or both of these devices. For example, the UE 112 may transmit authorization request 204 that may include data representing the UE 112's access data 163 to the UE 114 via sidelink communications 220. At operation 206, the UE 114 (e.g., an application executing on the UE 114, such as the authorization and/or access application 164) may verify the UE 112 based on the access data 163.

Additionally or alternatively, the UE 114 may transmit authorization request 208 that may include data representing the UE 114's access data 165 to the UE 114 via sidelink communications 220. At operation 210, the UE 112 (e.g., an application executing on the UE 112, such as the authorization and/or access application 162) may verify the UE 114 based on the access data 165.

Using the results of the verification(s), the UE 110 may initiate authorization operations. For example, the UE 112 may transmit authorization data message 212 to the UE 110 using sidelink communications 220. The authorization data message 212 may include data determined by the UE 112 based on the access data 165 received from the UE 114. For example, this data may include an indication that the UE 114 is sufficiently proximate to the UE 112 (e.g., due to the ability to establish a sidelink communications session at 202 and/or based on other location data for the UE(s)). The authorization data may also, or instead, include a verification of a relationship or association between the UE 112 and the UE 114.

Additionally or alternatively, the UE 114 may transmit authorization data message 214 to the UE 110 using sidelink communications 220. The authorization data message 214 include data determined by the UE 114 based on the access data 163 received from the UE 112. For example, this data may include an indication that the UE 112 is sufficiently proximate to the UE 114 (e.g., due to the ability to establish a sidelink communications session at 202 and/or based on other location data for the UE(s)). The authorization data may also, or instead, include a verification of a relationship or association between the UE 114 and the UE 112. The association between the UE may be any type of verifiable association, such as an exchange and processing of secret/public/private keys, codes, passwords, etc.

The UE 110 may use this authorization data to generate an authorization request 216 that may include some or all of the authorization data 212 and/or the authorization data 214. The UE 110, serving as a sidelink relay device, may transmit the authorization request 216 via a cellular communications 230 to the gNodeB 120 for transmission to the authorization and/or activation system 150. The system 150 may perform authorization operation(s) 218 to verify the UE 112 and/or the UE 114. For example, the system 150 may confirm that the authorization data 212 and/or the authorization data 214 indicates that the one or both of the UE 112 and the UE 114 are sufficiently proximate to the UE 110 and/or the system or item associated with the UE 110. The system may also, or instead, at operation(s) 218, verify one or more passwords, usernames, keys, codes, device identifiers, etc. associated with one or more of the UE 112 and the UE 114 and/or indicated in the authorization data 212 and/or the authorization data 214.

Based on these operations, the system 150 may transmit an authorization response 220 via cellular communications 230 and the gNodeB 120 to the UE 110. This response may include an allowance or denial of access to the system and/or item associated with the UE 110. Alternatively or additionally, this response may be instructions that may directly or indirectly cause the system or item associated with the UE 110 to allow or deny access. For example, the response 220 may include instructions that cause a safe deposit box to be unlocked or remain locked. The access operations 222 (allow or deny access) may be implemented at the UE 110 and/or at the system or item associated with the UE 110 based on the authorization response 220.

Signal flow 200 of FIG. 2 illustrates an example of signals that may be exchanged and operations that may be performed based on a user device verifying another user device or two or more user devices verifying one another (e.g., the UE 112 and the UE 114) via sidelink and then providing access data via sidelink to a sidelink relay device (the UE 110) for access authorization determination with a remote system (the system 150) via cellular communications.

In an example, the UE 112 and the UE 114 may establish a sidelink communications session with one another at operation 202. In examples, the UE 112 and the UE 114 may then engage in authorization operations to verify one or both of these devices. For example, the UE 112 may transmit authorization request 204 that may include data representing the UE 112's access data 163 to the UE 114 via sidelink communications 220. At operation 206, the UE 114 (e.g., an application executing on the UE 114, such as the authorization and/or access application 164) may verify the UE 112 based on the access data 163.

Additionally or alternatively, the UE 114 may transmit authorization request 208 that may include data representing the UE 114's access data 165 to the UE 114 via sidelink communications 220. At operation 210, the UE 112 (e.g., an application executing on the UE 112, such as the authorization and/or access application 162) may verify the UE 114 based on the access data 165.

Using the results of the verification(s), the UE 110 may initiate authorization operations. For example, the UE 112 may transmit authorization data message 212 to the UE 110 using sidelink communications 220. The authorization data message 212 include data determined by the UE 112 based on the access data 165 received from the UE 114. For example, this data may include an indication that the UE 114 is sufficiently proximate to the UE 112 (e.g., due to the ability to establish a sidelink communications session at 202 and/or based on other location data for the UE(s)). The authorization data may also, or instead, include a verification of a relationship or association between the UE 112 and the UE 114.

Additionally or alternatively, the UE 114 may transmit authorization data message 214 to the UE 110 using sidelink communications 220. The authorization data message 214 include data determined by the UE 114 based on the access data 163 received from the UE 112. For example, this data may include an indication that the UE 112 is sufficiently proximate to the UE 114 (e.g., due to the ability to establish a sidelink communications session at 202 and/or based on other location data for the UE(s)). The authorization data may also, or instead, include a verification of a relationship or association between the UE 114 and the UE 112. The association between the UE may be any type of verifiable association, such as an exchange and processing of secret/public/private keys, codes, passwords, etc.

The UE 110 may use this authorization data to generate an authorization request 216 that may include some or all of the authorization data 212 and/or the authorization data 214. The UE 110, serving as a sidelink relay device, may transmit the authorization request 216 via a cellular communications 230 to the gNodeB 120 for transmission to the authorization and/or activation system 150. The system 150 may perform authorization operation(s) 218 to verify the UE 112 and/or the UE 114. For example, the system 150 may confirm that the authorization data 212 and/or the authorization data 214 indicates that the one or both of the UE 112 and the UE 114 are sufficiently proximate to the UE 110 and/or the system or item associated with the UE 110. The system may also, or instead, at operation(s) 218, verify one or more passwords, usernames, keys, codes, device identifiers, etc. associated with one or more of the UE 112 and the UE 114 and/or indicated in the authorization data 212 and/or the authorization data 214.

Based on these operations, the system 150 may transmit an authorization response 220 via cellular communications 230 and the gNodeB 120 to the UE 110. This response may include an allowance or denial of access to the system and/or item associated with the UE 110. Alternatively or additionally, this response may be instructions that may directly or indirectly cause the system or item associated with the UE 110 to allow or deny access. For example, the response 220 may include instructions that cause a safe deposit box to be unlocked or remain locked. The access operations 222 (allow or deny access) may be implemented at the UE 110 and/or at the system or item associated with the UE 110 based on the authorization response 220.

Signal flow 200 of FIG. 2 illustrates an example of signals that may be exchanged and operations that may be performed based on a user device verifying another user device or two or more user devices verifying one another (e.g., the UE 112 and the UE 114) via sidelink and then providing access data via sidelink to a sidelink relay device (the UE 110) for access authorization determination with a remote system (the system 150) via cellular communications.

In an example, the UE 112 and the UE 114 may establish a sidelink communications session with one another at operation 202. In examples, the UE 112 and the UE 114 may then engage in authorization operations to verify one or both of these devices. For example, the UE 112 may transmit authorization request 204 that may include data representing the UE 112's access data 163 to the UE 114 via sidelink communications 220. At operation 206, the UE 114 (e.g., an application executing on the UE 114, such as the authorization and/or access application 164) may verify the UE 112 based on the access data 163.

Additionally or alternatively, the UE 114 may transmit authorization request 208 that may include data representing the UE 114's access data 165 to the UE 114 via sidelink communications 220. At operation 210, the UE 112 (e.g., an application executing on the UE 112, such as the authorization and/or access application 162) may verify the UE 114 based on the access data 165.

Using the results of the verification(s), the UE 110 may initiate authorization operations. For example, the UE 112 may transmit authorization data message 212 to the UE 110 using sidelink communications 220. The authorization data message 212 include data determined by the UE 112 based on the access data 165 received from the UE 114. For example, this data may include an indication that the UE 114 is sufficiently proximate to the UE 112 (e.g., due to the ability to establish a sidelink communications session at 202 and/or based on other location data for the UE(s)). The authorization data may also, or instead, include a verification of a relationship or association between the UE 112 and the UE 114.

Additionally or alternatively, the UE 114 may transmit authorization data message 214 to the UE 110 using sidelink communications 220. The authorization data message 214 include data determined by the UE 114 based on the access data 163 received from the UE 112. For example, this data may include an indication that the UE 112 is sufficiently proximate to the UE 114 (e.g., due to the ability to establish a sidelink communications session at 202 and/or based on other location data for the UE(s)). The authorization data may also, or instead, include a verification of a relationship or association between the UE 114 and the UE 112. The association between the UE may be any type of verifiable association, such as an exchange and processing of secret/public/private keys, codes, passwords, etc.

The UE 110 may use this authorization data to generate an authorization request 216 that may include some or all of the authorization data 212 and/or the authorization data 214. The UE 110, serving as a sidelink relay device, may transmit the authorization request 216 via a cellular communications 230 to the gNodeB 120 for transmission to the authorization and/or activation system 150. The system 150 may perform authorization operation(s) 218 to verify the UE 112 and/or the UE 114. For example, the system 150 may confirm that the authorization data 212 and/or the authorization data 214 indicates that the one or both of the UE 112 and the UE 114 are sufficiently proximate to the UE 110 and/or the system or item associated with the UE 110. The system may also, or instead, at operation(s) 218, verify one or more passwords, usernames, keys, codes, device identifiers, etc. associated with one or more of the UE 112 and the UE 114 and/or indicated in the authorization data 212 and/or the authorization data 214.

Based on these operations, the system 150 may transmit an authorization response 220 via cellular communications 230 and the gNodeB 120 to the UE 110. This response may include an allowance or denial of access to the system and/or item associated with the UE 110. Alternatively or additionally, this response may be instructions that may directly or indirectly cause the system or item associated with the UE 110 to allow or deny access. For example, the response 220 may include instructions that cause a safe deposit box to be unlocked or remain locked or that may be used to complete or deny completion of a financial transaction. The access operations 222 (allow or deny access) may be implemented at the UE 110 and/or at the system or item associated with the UE 110 based on the authorization response 220.

Signal flow 300 of FIG. 3 illustrates an example of signals that may be exchanged and operations that may be performed based on individual user devices (e.g., UE 112 and/or UE 114) verifying with and/or via a sidelink relay device (e.g., UE 110) (e.g., only, as opposed to verifying with one another) via sidelink and then the sidelink relay device providing access data for access authorization determination with a remote system (the system 150) via cellular communications.

In an example, the UE 112 may establish a sidelink communications session with the UE 110 at operation 302. The UE 114 may also, or instead, establish a sidelink communications session with the UE 110 at operation 304.

The UE 112 may then engage in authorization operations to verify itself with the UE 110. For example, the UE 112 may transmit authorization request 306 that may include data representing the UE 112's access data 163 to the UE 110 via sidelink communications 320. At operation 308, the UE 110 (e.g., an application executing on the UE 110, such as the authorization, access, and/or relay application 180) may verify the UE 112 based on the access data 163. This verification may include a determination that the UE 112 is sufficiently proximate to the UE 110 and/or the system or item whose access is associated with the UE 110. Alternatively or additionally, the UE 110 may use the access data 163 to generate an authorization request.

Additionally or alternatively, the UE 114 may transmit authorization request 310 that may include data representing the UE 114's access data 165 to the UE 110 via sidelink communications 320. At operation 312, the UE 110 (e.g., an application executing on the UE 110, such as the authorization, access, and/or relay application 180) may verify the UE 114 based on the access data 165. This verification may include a determination that the UE 114 is sufficiently proximate to the UE 110 and/or the system or item whose access is associated with the UE 110. Alternatively or additionally, the UE 110 may use the access data 165 to generate an authorization request.

Using the results of the verification(s), the UE 110 may initiate authorization operations. For example, the UE 110 may use the access data received from the UE 112 and/or the UE 114 and/or resulting authorization data to generate an authorization request 314 that may include some or all of such data. The UE 110, serving as a sidelink relay device, may transmit the authorization request 314 via a cellular communications 330 to the gNodeB 120 for transmission to the authorization and/or activation system 150. The system 150 may perform authorization operation(s) 316 to verify the UE 112 and/or the UE 114. For example, the system 150 may confirm that the authorization data represented in the authorization request 314 indicates that the one or both of the UE 112 and the UE 114 are sufficiently proximate to the UE 110 and/or the system or item associated with the UE 110. The system may also, or instead, at operation(s) 316, verify one or more passwords, usernames, keys, codes, device identifiers, etc. associated with one or more of the UE 112 and the UE 114 and/or indicated in the authorization request 314.

Based on these operations, the system 150 may transmit an authorization response 318 via cellular communications 330 and the gNodeB 120 to the UE 110. This response may include an allowance or denial of access to the system and/or item associated with the UE 110. Alternatively or additionally, this response may be instructions that may directly or indirectly cause the system or item associated with the UE 110 to allow or deny access. For example, the response 318 may include instructions that cause a safe deposit box to be unlocked or remain locked or that may be used to complete or deny completion of a financial transaction. The authorization operations 316 (allow or deny access) may be implemented at the UE 110 and/or at the system or item associated with the UE 110 based on the authorization response 318.

### Illustrative Operations

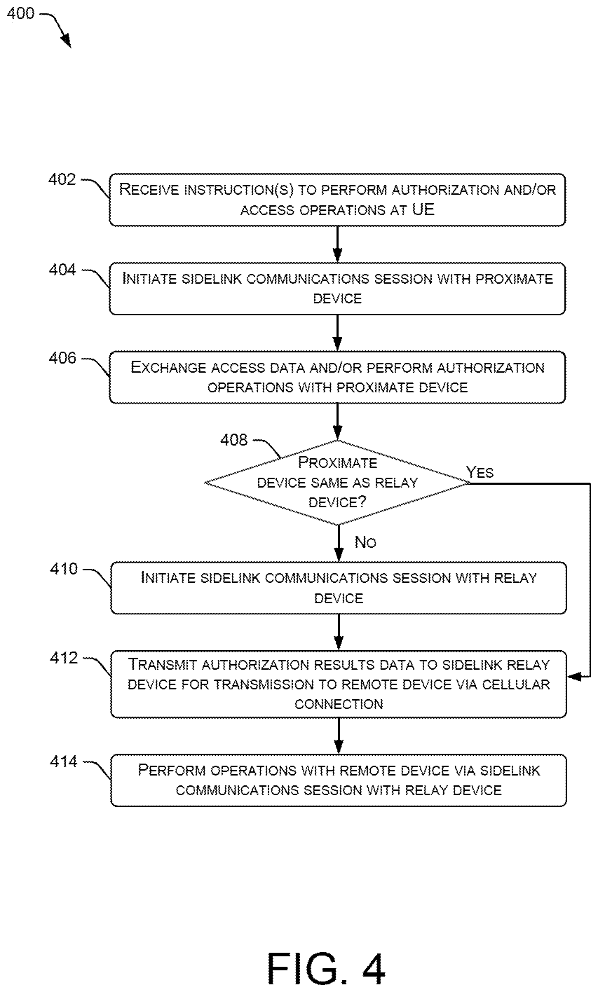

FIG. 4 shows a flow diagram of an illustrative process 400 for performing access and/or authorization operations according to the systems and methods of the instant disclosure. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1, however, other environments may also be used.

At operation 402, a UE may receive and/or detect one or more instructions to perform one or more authorization and/or access operations. For example, an application executing on the UE may receive a command to initiate an access request operations. For instance, an access and/or authorization application may be initiated by user activation of an interface control element (e.g., icon, button, etc.). This application may be an application for accessing a space or item (e.g., a safe deposit box, a restricted area, etc.) and/or an application for confirming authorization of a transaction of any type (e.g., a financial transaction requiring two or more verified users).

At operation 404, the UE may initiate a sidelink communications session with a physically proximate device. For example, the UE may detect and/or transmit signals on the bands associated with its cellular capabilities (e.g., 3GPP LTE, NR, and/or 6G bands) to detect proximate devices. The UE may determine if one or more detected devices are capable of establishing a sidelink communications session and/or may initiate a sidelink communications session with one or more such devices. For instance, an application configured on the UE may be configured to detect devices and initiate cellular standard-supported sidelink communications with other devices. In particular examples, the UE may be one of the UE 110, the UE 112, or the UE 114 as described above, with one or more of the remaining UEs being detected as proximate devices.

At 406, the UE may exchange access data with the UE(s) with which it has established at sidelink communications. For example, one of the UEs communicating via sidelink may perform authorization operations using exchanged usernames, passwords, keys and/or key combinations of any type, device identifiers, etc. to verify the other UE, and vice versa. In examples, both such UEs may be sidelink remote devices (e.g., the UE 112 and the UE 114) verifying one another, while in other examples, one such UE may be a sidelink remote devices (e.g., one of the UE 112 or the UE 114) and the other UE may be a sidelink relay device (e.g., the UE 110).

At operation 408, a determination may be made as to whether the UE with which the UE receiving the instructions at operation 402 has verified itself is a sidelink relay UE (e.g., the UE 110). If not, at operation 410, the UE performing the prior operations may initiate a sidelink communications session with the sidelink relay device, for example, in a similar manner as operation 404.

At operation 412, after sidelink communications have been established with the sidelink relay device (either at operation 410 or at operation 404), the UE may provide access data and/or authorization results data to the sidelink relay device for processing and/or transmission via cellular communications to a remote access management device (e.g., the authorization and/or activation system 150).

At operation 414, the UE may perform one or more access operations based on or otherwise using sidelink communications with the relay UE. For example, the UE may provide an interface to the user indicating whether the requested access or authorization has been allowed or denied. The UE may otherwise interact with the relay UE and/or the remote system via the relay UE to perform any other access and/or authorization operations.

In summary, by using secure sidelink communication supported by a cellular communications standard for short-range communications, the disclosed systems and techniques may increase the efficiency of usage of device and wireless network resources by eliminating the need for separate short-range communication resources and improve the performance and security of both the network and user devices.

### Example User Equipment

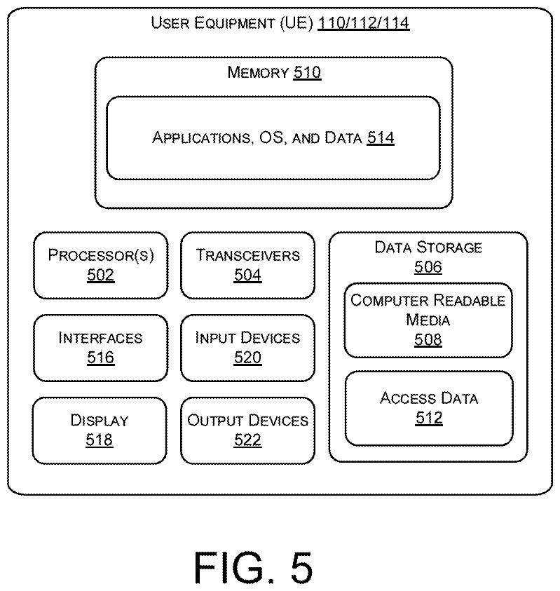

FIG. 5 is an example of a UE, such as one or more of the UE 110, the UE 112, and/or the UE 114, for use with the systems and methods disclosed herein, in accordance with examples of the present disclosure. The UE 110/112/114 may include one or more processors 502, one or more transmit/receive antennas (e.g., transceivers or transceiver antennas) 504, and a data storage 506. The data storage 506 may include a computer-readable media 508 in the form of memory and/or cache. This computer-readable media may include a non-transitory computer-readable media. The data storage 506 may include access data 512 that may be used for the authorization and access operations described herein. The processor(s) 502 may be configured to execute instructions, which can be stored in the computer-readable media 508 and/or in other computer-readable media accessible to the processor(s) 502. In some configurations, the processor(s) 502 is a Central Processing Unit (CPU), a Graphics Processing Unit (GPU), or both CPU and GPU, or any other sort of processing unit. The transceiver antenna(s) 504 can exchange signals with a base station, such as gNodeB 120.

The UE 110/112/114 may be configured with a memory 510. The memory 510 may be implemented within, or separate from, the data storage 506 and/or the computer-readable media 508. The memory 510 may include any available physical media accessible by a computing device to implement the instructions stored thereon. For example, the memory 510 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110/112/114.

The memory 510 can store several modules, such as instructions, data stores, and so forth that are configured to execute on the processor(s) 502. In configurations, the memory 510 may also store one or more applications 514 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., the gNodeB 120). The applications 514 may also include one or more operating systems and/or one or more third-party applications that provide additional functionality to the UE 110/112/114. The memory may also, or instead, store bandwidth information, such as UE-supported bands, bandwidth(s) and bandwidth parts, as well as communications session information such as UE-specific carrier bandwidth(s). The memory may also, or instead, store access data, access and/or authorization applications, authorization, access, and/or relay applications, etc.

Although not all illustrated in FIG. 5, the UE 110/112/114 may also comprise various other components, e.g., a battery, a charging unit, one or more network interfaces 516, an audio interface, a display 518, a keypad or keyboard, and one or more input devices 520, and one or more output devices 522.

### Example Computing Device

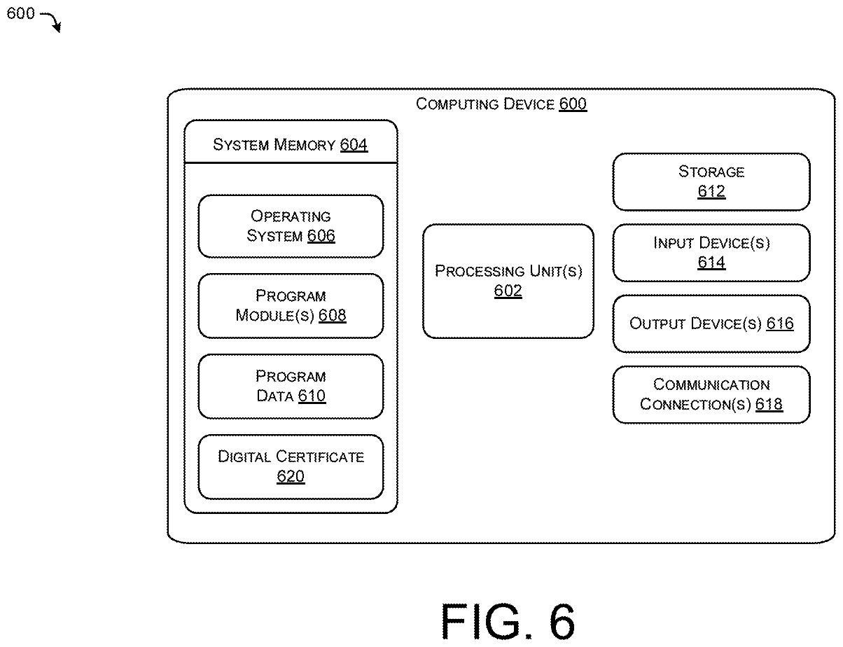

FIG. 6 is an example of a computing device 600 for use with the systems and methods disclosed herein, in accordance with examples of the present disclosure. The computing device 600 can be used to implement various components of a network, a base station (e.g., gNodeB 120), an authorization and/or activation system (e.g., authorization and/or activation system 150), and/or any servers, routers, gateways, gateway elements, administrative components, etc. that can be used by a communication provider. One or more computing devices 600 can be used to implement the network 170, for example. One or more computing devices 600 can also be used to implement base stations and other components.

In various embodiments, the computing device 600 can include one or more processing units 602 and system memory 604. Depending on the exact configuration and type of computing device, the system memory 604 can be volatile (such as RAM), non-volatile (such as ROM, flash memory, etc.) or some combination of the two. The system memory 604 can include an operating system 606, one or more program modules 608, program data 610, and one or more digital certificates 620. The system memory 604 may be secure storage or at least a portion of the system memory 604 can include secure storage. The secure storage can prevent unauthorized access to data stored in the secure storage. For example, data stored in the secure storage can be encrypted or accessed via a security key and/or password.

The computing device 600 can also include additional data storage devices (removable and/or non-removable) such as, for example, magnetic disks, optical disks, or tape. Such additional storage is illustrated in FIG. 6 by storage 612. The computing device 600 may store, in either or both of the system memory 604 and the storage 612, access data, applications, etc.

Non-transitory computer storage media of the computing device 600 can include volatile and nonvolatile, removable and non-removable media implemented in any method or technology for storage of information, such as computer-readable instructions, data structures, program modules, or other data. The system memory 604 and storage 612 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 600. Any such non-transitory computer-readable storage media can be part of the computing device 600.

In various embodiments, any or all of the system memory 604 and storage 612 can store programming instructions which, when executed, implement some or all of the functionality described above as being implemented by one or more systems configured in the environment 100 and/or components of the network 170.

The computing device 600 can also have one or more input devices 614 such as a keyboard, a mouse, a touch-sensitive display, voice input device, etc. The computing device 600 can also have one or more output devices 616 such as a display, speakers, a printer, etc. can also be included. The computing device 600 can also contain one or more communication connections 618 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.

A: A method performed by a one or more computing devices configured in a wireless communications network, the method comprising: receiving, at a first user equipment (UE) from a second UE, via a first sidelink communications connection, first access data; receiving, at the first UE from a third UE, via a second sidelink communications connection, second access data; generating, by the first UE, a request for access to a restricted item based at least in part on the first access data and the second access data; transmitting, from the first UE to an authorization system, via a cellular communications connection, the request for access to the restricted item; receiving, at the first UE from the authorization system, via the cellular communications connections, an authorization response based at least in part on the request for access to the restricted item; and providing access, by the first UE, to the restricted item based at least in part on the authorization response.

B: The method of paragraph A, wherein providing access to the restricted item comprises allowing access to the restricted item based at least in part on the authorization response.

C: The method of paragraph B, wherein allowing access to the restricted item comprises one or more of unlocking a safe deposit box or permitting physical access to a restricted space.

D: The method of any of paragraphs A-C, wherein providing access to the restricted item comprises denying access to the restricted item based at least in part on the authorization response.

E: The method of any of paragraphs A-D, wherein each of the first sidelink communications connection and the second sidelink communications connection comprises one of: a 3GPP 4G sidelink communications connection, a 3GPP 5G sidelink communications connection, or a 3GPP 6G sidelink communications connection.

F: The method of any of paragraphs A-E, wherein each of the first access data and the second access data comprises one or more of: a username, a password, a key, a device identifier, or a user identifier.

G: A sidelink relay user equipment (UE) comprising: one or more processors; one or more transceivers; and non-transitory computer-readable media storing computer-executable instructions that, when executed by the one or more processors, cause the one or more processors to perform operations comprising: receiving, via a sidelink communications connection, access data associated with one or more UEs; generating a request for access to a restricted item based at least in part on the access data; transmitting, to an authorization system, via a cellular communications connection, the request for access to the restricted item; receiving, from the authorization system, via the cellular communications connections, an authorization response based at least in part on the request for access to the restricted item; and providing access to the restricted item based at least in part on the authorization response.

H: The sidelink relay UE of paragraph G, wherein the request for access to a restricted item comprises an indication that the one or more UEs are sufficiently proximate to the sidelink relay UE.

I: The sidelink relay UE of paragraph H, wherein the indication that the one or more UEs are sufficiently proximate to the sidelink relay UE comprises an indication that the one or more UEs established sidelink communications with the sidelink relay UE.

J: The sidelink relay UE of any of paragraphs G-I, wherein the request for access to a restricted item comprises an indication of a location of the one or more UEs.

K: The sidelink relay UE of any of paragraphs G-J, wherein the access data is received from a first UE and comprises first access data for the first UE and second access data for a second UE.

L: The sidelink relay UE of any of paragraphs G-K, wherein receiving the access data comprises: receiving first access data for a first UE from the first UE; and receiving second access data for a second UE from the second UE.

M: The sidelink relay UE of any of paragraphs G-L, wherein providing access to the restricted item comprises authorizing a financial transaction based at least in part on the authorization response.

N: The sidelink relay UE of any of paragraphs G-M, wherein providing access to the restricted item comprises allowing access to a physical space or a physical item based at least in part on the authorization response.

O: A non-transitory computer-readable media storing computer-executable instructions that, when executed by one or more processors, cause the one or more processors to perform operations comprising: receiving, at a sidelink relay (UE), via a sidelink communications connection, access data associated with one or more UEs; generating, by the sidelink relay UE, a request for access to a restricted item based at least in part on the access data; transmitting, from the sidelink relay UE to an authorization system, via a cellular communications connection, the request for access to the restricted item; receiving, at the sidelink relay UE from the authorization system, via the cellular communications connections, an authorization response based at least in part on the request for access to the restricted item; and providing access, by the sidelink relay UE, to the restricted item based at least in part on the authorization response.

P: The non-transitory computer-readable media of paragraph O, wherein providing access to the restricted item comprises allowing access to a physical space or a physical item based at least in part on the authorization response.

Q: The non-transitory computer-readable media of paragraph O or P, wherein the request for access to a restricted item comprises an indication of a location of the one or more UEs.

R: The non-transitory computer-readable media of any of paragraphs O-Q, wherein the indication of the location of the one or more UEs is based at least in part on an establishment of the sidelink communications connection.

S: The non-transitory computer-readable media of any of paragraphs O-R, wherein the sidelink communications connection comprises one of: a 3GPP 4G sidelink communications connection, a 3GPP 5G sidelink communications connection, or a 3GPP 6G sidelink communications connection.

T: The non-transitory computer-readable media of any of paragraphs O-S, wherein the cellular communications connection comprises one of: a 3GPP 4G cellular communications connection, a 3GPP 5G cellular communications connection, or a 3GPP 6G cellular communications connection.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes that come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a one or more computing devices configured in a wireless communications network, the method comprising:
receiving, at a first user equipment (UE) from a second UE, via a first sidelink communications connection, first access data;
receiving, at the first UE from a third UE, via a second sidelink communications connection, second access data;
generating, by the first UE, a request for access to a restricted item based at least in part on the first access data and the second access data;
transmitting, from the first UE to an authorization system, via a cellular communications connection, the request for access to the restricted item;
receiving, at the first UE from the authorization system, via the cellular communications connections, an authorization response based at least in part on the request for access to the restricted item; and
providing access, by the first UE, to the restricted item based at least in part on the authorization response.

2. The method of claim 1, wherein providing access to the restricted item comprises allowing access to the restricted item based at least in part on the authorization response.

3. The method of claim 2, wherein allowing access to the restricted item comprises one or more of unlocking a safe deposit box or permitting physical access to a restricted space.

4. The method of claim 1, wherein providing access to the restricted item comprises denying access to the restricted item based at least in part on the authorization response.

5. The method of claim 1, wherein each of the first sidelink communications connection and the second sidelink communications connection comprises one of:
a 3GPP 4G sidelink communications connection,
a 3GPP 5G sidelink communications connection, or
a 3GPP 6G sidelink communications connection.

6. The method of claim 1, wherein each of the first access data and the second access data comprises one or more of:
a username,
a password,
a key,
a device identifier, or
a user identifier.

7. A sidelink relay user equipment (UE) comprising:
one or more processors;
one or more transceivers; and
non-transitory computer-readable media storing computer-executable instructions that, when executed by the one or more processors, cause the one or more processors to perform operations comprising:
receiving, via a sidelink communications connection, access data associated with one or more UEs;
generating a request for access to a restricted item based at least in part on the access data;
transmitting, to an authorization system, via a cellular communications connection, the request for access to the restricted item;
receiving, from the authorization system, via the cellular communications connections, an authorization response based at least in part on the request for access to the restricted item; and
providing access to the restricted item based at least in part on the authorization response.

8. The sidelink relay UE of claim 7, wherein the request for access to a restricted item comprises an indication that the one or more UEs are sufficiently proximate to the sidelink relay UE.

9. The sidelink relay UE of claim 8, wherein the indication that the one or more UEs are sufficiently proximate to the sidelink relay UE comprises an indication that the one or more UEs established sidelink communications with the sidelink relay UE.

10. The sidelink relay UE of claim 7, wherein the request for access to a restricted item comprises an indication of a location of the one or more UEs.

11. The sidelink relay UE of claim 7, wherein the access data is received from a first UE and comprises first access data for the first UE and second access data for a second UE.

12. The sidelink relay UE of claim 7, wherein receiving the access data comprises:
receiving first access data for a first UE from the first UE; and
receiving second access data for a second UE from the second UE.

13. The sidelink relay UE of claim 7, wherein providing access to the restricted item comprises authorizing a financial transaction based at least in part on the authorization response.

14. The sidelink relay UE of claim 7, wherein providing access to the restricted item comprises allowing access to a physical space or a physical item based at least in part on the authorization response.

15. A non-transitory computer-readable media storing computer-executable instructions that, when executed by one or more processors, cause the one or more processors to perform operations comprising:
receiving, at a sidelink relay (UE), via a sidelink communications connection, access data associated with one or more UEs;
generating, by the sidelink relay UE, a request for access to a restricted item based at least in part on the access data;
transmitting, from the sidelink relay UE to an authorization system, via a cellular communications connection, the request for access to the restricted item;
receiving, at the sidelink relay UE from the authorization system, via the cellular communications connections, an authorization response based at least in part on the request for access to the restricted item; and
providing access, by the sidelink relay UE, to the restricted item based at least in part on the authorization response.

16. The non-transitory computer-readable media of claim 15, wherein providing access to the restricted item comprises allowing access to a physical space or a physical item based at least in part on the authorization response.

17. The non-transitory computer-readable media of claim 15, wherein the request for access to a restricted item comprises an indication of a location of the one or more UEs.

18. The non-transitory computer-readable media of claim 17, wherein the indication of the location of the one or more UEs is based at least in part on an establishment of the sidelink communications connection.

19. The non-transitory computer-readable media of claim 15, wherein the sidelink communications connection comprises one of:
a 3GPP 4G sidelink communications connection,
a 3GPP 5G sidelink communications connection, or
a 3GPP 6G sidelink communications connection.

20. The non-transitory computer-readable media of claim 15, wherein the cellular communications connection comprises one of:
a 3GPP 4G cellular communications connection,
a 3GPP 5G cellular communications connection, or
a 3GPP 6G cellular communications connection.
